(19) United States
(12) Patent Application Publication
(10) Pub. No.: US 2020/0091854 A1
(43) Pub. Date: Mar. 19, 2020

(54) INVERTER CONTROL METHOD

(71) Applicant: Nidec Elesys Corporation, Kawasaki-shi (JP)

(72) Inventor: Tokuji TATEWAKI, Kawasaki-shi (JP)

(21) Appl. No.: 16/551,769

(22) Filed: Aug. 27, 2019

(30) Foreign Application Priority Data
Sep. 19, 2018 (JP) 2018-174938

(51) Int. Cl. H02P 27/08; H02M 7/5387; B62D 5/04

(52) U.S. Cl. CPC H02P 27/08; B62D 5/0463; H02M 7/53871

(57) ABSTRACT

An inverter control method for preventing an increase or decrease fluctuation of a duty ratio of a pulse width modulation signal due to the dead time and suppressing generation of a torque ripple. A duty converter performs duty conversion on an input voltage waveform to a motor terminal voltage input circuitry to which a motor terminal voltage corresponding to each phase of an electric motor is input, and sets it as a detected duty. A command duty correction circuitry adds, to the command duty generated by a command duty generator, a differential duty that is a difference between the command duty and the detected duty, or subtracts the differential duty from the command duty, according to the direction of the phase current. Thereby, duty correction is performed to match the switching characteristics of the phase current before correction with the ideal characteristics.

### CROSS REFERENCE TO RELATED APPLICATION

The present invention claims priority under 35 U.S.C. § 119 to Japanese Application No. 2018-174938 filed on Sep. 19, 2018 the entire content of which is incorporated herein by reference.

### 1. FIELD OF THE INVENTION

The present invention relates to, an inverter control method for an inverter circuit included in a motor control circuitry of an electric power steering apparatus, for example.

### 2. BACKGROUND

In a motor control device, in the case of driving a motor through pulse width modulation (PWM) by an inverter circuit configured of a pair of switching elements (a high side (HiSide) switching element and a low side (LoSide) potential switching element) provided corresponding to the motor phase between positive and negative electrodes of a DC power supply, when the two switching elements forming a pair are turned on simultaneously due to an operation delay time or the like of the switching element, a short circuit occurs between the positive and negative electrodes of the DC power supply. Therefore, conventionally, in inverter control, a period (dead time) in which the two switching elements forming the pair are simultaneously turned off is set, in order to prevent a short circuit of the switching elements.

For example, a conventional motor control device discloses a configuration of, in order to mitigate an effect of the dead time in which the motor control device cannot control output voltage during the dead time, calculating a dead time compensation amount based on the polarity and the magnitude of a current command value, adding the dead time compensation amount to a voltage command value to obtain a corrected voltage command value, generating a pulse width modulation signal based on the corrected voltage command value, thereby controlling the motor by turning on/off the switching element via the inverter circuit.

A conventional inverter discloses a configuration of, in a PWM type voltage source inverter that calculates a PWM switching pattern of three phases (U, V, W) according to a voltage command of two axes of d-q, compensating a voltage error between the PWM voltage command and the output voltage due to a dead band.

As described above, in the PWM control for an inverter bridge circuit of a motor control device, when a dead time is provided so as to prevent a short circuit between the high side (HiSide) FET and the low side (LoSide) FET forming the bridge circuit, there is a problem that a torque ripple caused by a step is generated due to an error between the command current (target current) and the actual current in the PWM control when the current path between the high side FET and the low side FET is switched.

In particular, when a flow of low current (for example, around 50% duty) is desired as a motor driving current, the effect of adding a dead time becomes large, and there is a problem that it is difficult to flow a target current. When such a motor control device is incorporated in electric power steering control, for example, since control of a low current is performed near the middle of the steering wheel, the current is insufficient or excess near the middle of the steering wheel. Thereby, torque ripple is noticeably generated.

In conventional inverter, the time in which an error between a voltage command and an output voltage caused by the dead time occurs is counted by a timer, the time output from the timer is converted into a voltage error, and voltage correction is made by subtracting or adding the voltage error from or to the voltage command. Therefore, there is a problem that it is difficult to cope with an increase or a decrease in the duty ratio of the PWM signal due to addition of the dead time.

Further, although the phase current of a motor is detected in a conventional motor control device or inverter, when an error occurs in the current detection circuit, it is difficult to determine whether or not the actual current and the assumed current match. Therefore, there is a problem that it is difficult to correct the dead time according to the direction of the current.

### SUMMARY

Preferred embodiments of the present invention are able to solve the problems described above. That is, a first example embodiment of the present disclosure provides an inverter control method that controls an inverter circuit that drives a motor. The method includes detecting a terminal voltage of the motor driven by a predetermined pulse width modulation signal, generating an actual duty ratio at a time of driving the motor based on the terminal voltage, calculating a difference between a command duty ratio corresponding to target motor drive and the actual duty ratio as a differential duty ratio, correcting the command duty ratio based on the differential duty ratio, and generating a pulse width modulation signal used in controlling the inverter circuit based on a post-correction command duty ratio obtained by the correction.

A second example embodiment of the present disclosure provides a motor control device including an inverter circuit that drives a motor. The device includes circuitry configured to detect a terminal voltage of the motor driven by a predetermined pulse width modulation signal, circuitry configured to generate a pulse width modulation signal that controls the inverter circuit according to the inverter control method according to the first example embodiment based on the terminal voltage, and circuitry configured to control the motor by the pulse width modulation signal generated.

A third example embodiment of the present disclosure provides a motor control device of an electric power steering that assists a steering wheel operation by an operator of a vehicle or the like. The device includes circuitry configured to detect a terminal voltage of a motor driven by a predetermined pulse width modulation signal, circuitry configured to generate a pulse width modulation signal that controls the inverter circuit according to the inverter control method according to the first example embodiment based on the terminal voltage, and circuitry configured to control the motor based on the pulse width modulation signal generated.

A fourth example embodiment of the present disclosure provides an electric power steering system including the motor control device of the electric power steering according to the third example embodiment.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a block diagram showing an overall configuration of a motor control device that executes an inverter control method according to the present disclosure.

FIG. 2 is a diagram showing how the phase current in the positive direction flows from the FETs to the motor in a motor drive circuitry.

FIG. 3 is a diagram showing the correspondence between the ON/OFF states of the FETs, FET drive waveform, detected waveforms of the motor terminal voltages, and the like when the phase current flows in the positive direction.

FIG. 4 is a diagram showing how the phase current in the negative direction flows from the motor to the FETs in the motor drive circuitry.

FIG. 5 is a diagram showing the correspondence between the ON/OFF states of the FETs, the FET drive waveform, the detected waveforms of the motor terminal voltages, and the like when the phase current flows in the negative direction.

FIG. 6 schematically shows how duty correction is performed in the inverter control method.

FIG. 7 is a flowchart showing an example of a duty correction process by a controller.

FIG. 8 is a schematic configuration diagram of an electric power steering apparatus equipped with a motor control device controlled by the inverter control method according to the present example embodiment.

FIG. 9 is a block diagram showing a configuration of a motor control device according to a first modification.

FIG. 10 is a block diagram showing a configuration of a motor control device according to a second modification.

FIG. 11 is a block diagram showing a configuration of a motor control device according to a third modification.

### DETAILED DESCRIPTION

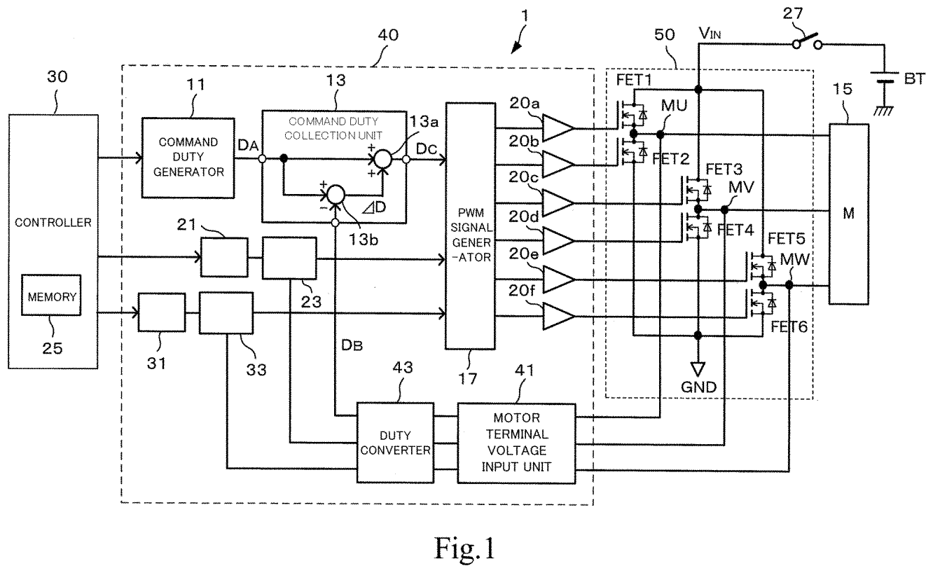

An example embodiment of the present disclosure will be described in detail below with reference to the accompanying drawings. FIG. 1 is a block diagram showing an overall configuration of a motor control device that executes an inverter control method according to the present disclosure.

A motor control device 1 shown in FIG. 1 includes a controller 30 configured of, for example, a microprocessor responsible for control of the entire device, a pre-driver circuitry 40 that generates a motor driving signal by a control signal from the controller 30 and functions as a FET drive circuit, a motor drive circuitry 50 serving as an inverter circuit (motor drive circuit) that supplies a predetermined driving current to an electric motor 15.

To the motor drive circuitry 50, a power supply for driving the motor is supplied from an external battery BT via a power supply relay 27. The power supply relay 27 can be formed so as to be able to cut off the power from the battery BT, and may be formed of a semiconductor relay. The motor drive circuitry 50 is an FET bridge circuit configured of a plurality of semiconductor switching elements (FET1 to FET6). In FIG. 1, illustration of a switching FET for supplying the driving current to the electric motor 15 is omitted.

The electric motor 15 is, for example, a three-phase brushless DC motor, and the above-described FET bridge circuit is an inverter circuit having three phases (U phase, V phase, W phase) The semiconductor switching elements (FET1 to FET6) constituting the inverter circuit correspond to the respective phases of the electric motor 15. Specifically, the FETs 1 and 2 correspond to the U-phase, the FETs 3 and 4 correspond to the V-phase, and the FETs 5 and 6 correspond to the W-phase, respectively.

The FETs 1, 3, and 5 are upper-arm (also referred to as high-side (HiSide)) switching elements in the U-phase, the V-phase, and the W-phase, respectively, and the FETs 2, 4, and 6 are lower-arm (also referred to as low-side (LoSide)) switching elements in the U-phase, the V-phase, and the W-phase, respectively. A switching element is also referred to as a power element. For example, a switching element such as a metal-oxide semiconductor field-effect transistor (MOSFET) or an insulated gate bipolar transistor (IGBT) is used.

The drain terminals of the FETs 1, 3, and 5 constituting the bridge circuit are connected to the power supply side, and the source terminals thereof are connected to the drain terminals of the FETs 2, 4, and 6, respectively. The source terminals of the FETs 2, 4, and 6 are connected to the ground (GND) side.

The pre-driver circuitry 40 includes a motor terminal voltage input circuitry 41 to which voltages of motor terminals (MU terminal, MV terminal, MW terminal) corresponding to the respective phases of the electric motor 15 are input, and a duty converter 43 that converts the duty of the input voltage waveform input to the motor terminal voltage input circuitry 41.

The pre-driver circuitry 40 further includes command duty generators 11, 21, and 31 each of which generates duty of a PWM signal in response to a command from the controller 30, and command duty correction circuitries 13, 23, and 33 each of which performs correction, to be described below, in response to command duty generated by the command duty generators 11, 21, and 31, corresponding to the respective phases of U, V, and W.

In FIG. 1, the motor terminal voltage input circuitry 41 and the duty converter 43 may be provided corresponding to each of the U, V, and W phases.

The PWM signal generator 17 generates an ON/OFF control signal (PWM signal) of the semiconductor switching element of the motor drive circuitry 50 in accordance with post-correction command duty. At the output side of the PWM signal generator 17, drivers (pre-drivers) 20a to 20f that drive the switching elements (FET1 to FET6) are arranged.

Specifically, the drivers 20a, 20c, and 20e drive the high-side (HiSide) FETs 1, 3, and 5 of the motor drive circuitry (inverter circuit) 50, respectively, and the drivers 20b, 20d, and 20f drive the low-side (LoSide) FETs 2, 4, and 6 of the motor drive circuitry 50, respectively.

Note that in the motor control device 1, for example, a motor control integrated circuit (pre-driver IC) integrated with the pre-driver circuitry 40 including the PWM signal generator 17, the drivers 20a to 20f, the motor terminal voltage input circuitry 41, the duty converter 43, and the like, may be configured.

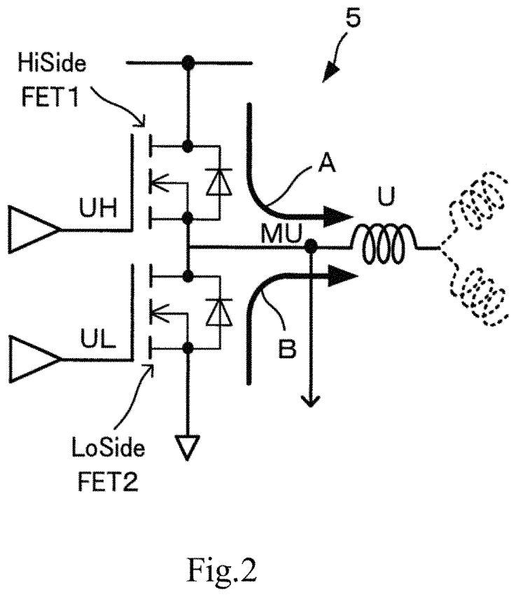

Next, an inverter control method according to the present example embodiment will be specifically described. FIGS. 2 to 5 show the relationship between the direction of phase current and the motor terminal voltage in the motor control device 1 shown in FIG. 1 at each switching timing of the semiconductor switching elements (FETs) of the motor drive circuitry 50. Although FIGS. 2 to 5 illustrate only the U phase, the same applies to the other phases.

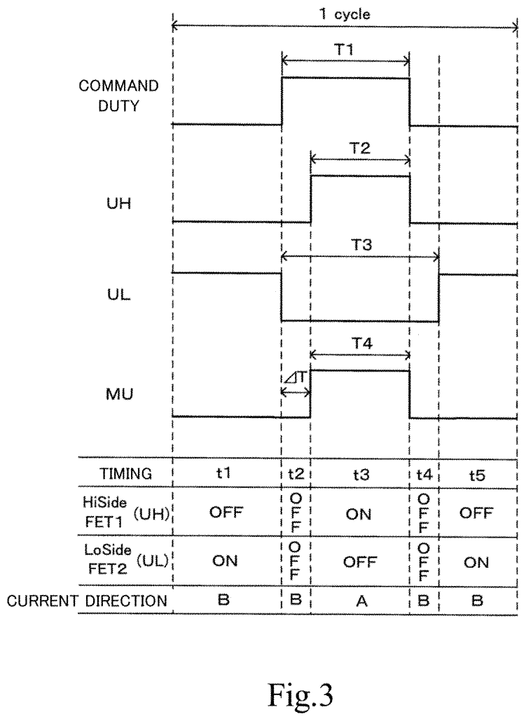

FIG. 2 shows how the phase current in the positive direction flows from the FETs 1 and 2 to the U-phase of the motor in the motor drive circuitry 50. FIG. 3 shows the correspondence between the ON/OFF states of the FETs 1 and 2, the FET drive waveform, the detected waveforms of the motor terminal voltages, and the like when the phase current flows in the positive direction, in only one cycle of a PWM signal.

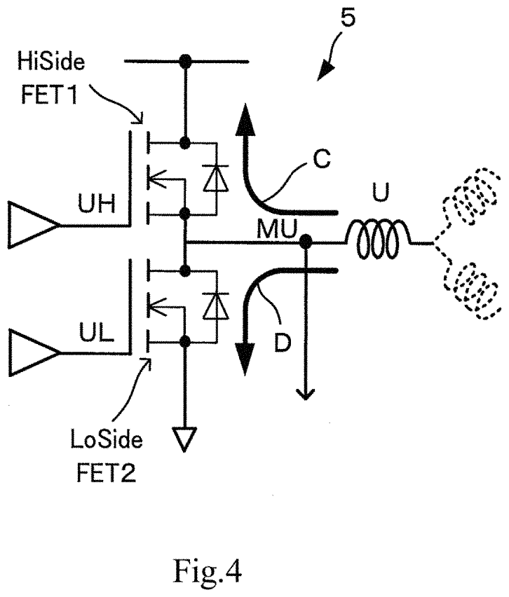

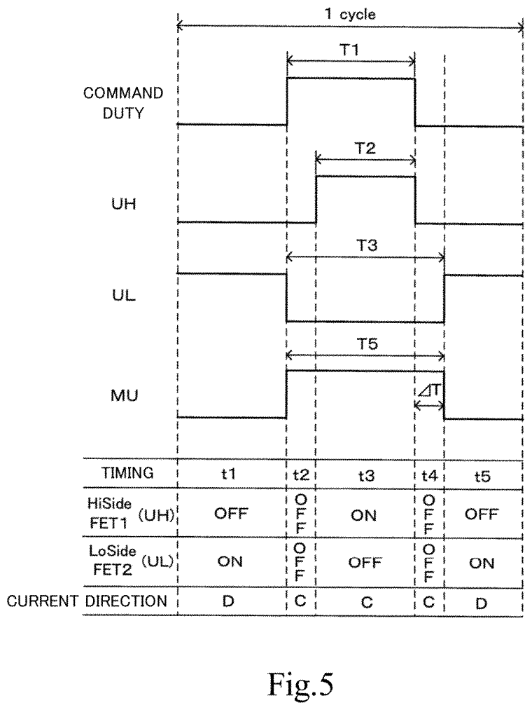

On the other hand, FIG. 4 shows how the phase current in the negative direction flows from FETs 1 and 2 to the U phase of the motor in the motor drive circuitry 50, and FIG. 5 shows the correspondence between the ON/OFF states of the FETs when the phase current flows in the negative direction, and the FET drive waveform, the motor terminal voltage waveform, and the like for one cycle of a PWM signal.

Note that whether the phase current flows in the positive direction or in the negative direction does not depend on the duty ratio of the drive pulse of that phase, but on the potential difference with another phase (difference from the duty ratio of a drive pulse of another phase).

First, the case where a positive current flows to the U phase will be described. In the motor control device 1 of FIG. 1, the command duty generator 11 outputs command duty (duty is T1) shown in FIG. 3. The command duty is a duty ratio of a PWM drive signal for outputting a target torque by the motor.

At timing t3 in FIG. 3, the HiSide-FET 1 is controlled to be in the energized state (ON state) and the LoSide-FET 2 is controlled to be in the non-energized state (OFF state), and a positive current denoted by a symbol A in FIG. 2 flows from the FET 1 to the U phase. Further, at timings t1 and t5, the FET 2 is controlled to be ON and the FET 1 is controlled to be OFF, and a positive current denoted by a symbol B in FIG. 2 flows from the FET 2 toward the U phase.

As described above, in the inverter control, a short circuit state in which the HiSide-FET and the LoSide-FET are simultaneously turned on is prevented. Therefore, as shown in FIG. 3, dead times (timings t2 and t4) at which both the FETs 1 and 2 are turned off are provided. At these timings t2 and t4, since the MU terminal in FIG. 2 is at a low potential, even if both the FETs 1 and 2 are off, the inductance component of the U phase of the motor causes the current to continuously flow in the same direction as that described above via the freewheeling diode of FET 2. As a result, the positive current indicated by the symbol B in FIG. 2 continues to flow from the FET 2 to the U phase.

The MU signal waveform in FIG. 3 is a waveform when the voltage of the motor terminal (MU) input to the motor terminal voltage input circuitry 41 is converted to duty by the duty converter 43, when the phase current flows in the positive direction. As described above, the drive signal UH of the FET 1 and the drive signal UL of the FET 2 are pulse waveforms each including a dead time. The duty T2 of the drive signal UH is smaller than the duty T1 of the command duty by an amount corresponding to the dead time (referred to as ΔT). As a result, when the phase current is flowing in the positive direction, the duty T4 of the MU signal has a waveform in which the duty is smaller by ΔT than the duty T1 of the command duty.

Next, the case where a negative current flows in the U phase will be described. In this case, the command duty (duty T1) shown in FIG. 5 is output from the command duty generator 11. At timing t3 in FIG. 5, the HiSide-FET 1 is controlled to the ON state and the LoSide-FET 2 is controlled to the OFF state, and a negative current denoted by a symbol C in FIG. 4 flows from the U phase toward the FET1.

At timings t1 and t5, the FET 2 is controlled to be ON and the FET 1 is controlled to be OFF, whereby a negative current denoted by a symbol D in FIG. 4 flows from the U phase to the FET 2.

In the inverter control, even when a phase current in the negative direction flows, dead times (timings t2 and t4) at which both the FETs 1 and 2 are turned off are provided as shown in FIG. 5 in order to prevent a short circuit state in which the HiSide-FET and the LoSide-FET are simultaneously turned on.

At this time, since the MU terminal in FIG. 4 is at a high potential, even if both the FETs 1 and 2 are OFF, the inductance component of the U phase of the motor causes the current to continuously flow in the same direction as that described above via the freewheeling diode of FET1. As a result, a negative current denoted by the symbol C in FIG. 4 flows from the U phase toward the FET 1.

The MU signal in FIG. 5 shows a waveform when the voltage of the motor terminal (MU) input to the motor terminal voltage input circuitry 41 is converted to duty by the duty converter 43, when the phase current flows in the negative direction. In this case, since the dead time is provided to each of the drive signal UH of FET1 and the drive signal UL of FET2, the duty T2 of the drive signal UH is larger than the duty T1 of the command duty by an amount corresponding to the dead time (ΔT). As a result, when the phase current is flowing in the negative direction, the duty T5 of the MU signal has a waveform in which the duty exceeds by ΔT than the duty T1 of the command duty.

That is, the MU signal in FIG. 3 has a waveform (also referred to as detected duty) obtained by the duty converter 43 through duty conversion performed on the voltage waveform of the MU terminal when the duty is insufficient compared with the command duty due to the dead time. Further, the MU signal in FIG. 5 has a waveform (detected duty) obtained by the duty converter 43 through duty conversion performed on the voltage waveform of the MU terminal when the duty exceeds the command duty due to the dead time.

In the inverter control method according to the present example embodiment, since the dead time is provided to the drive signal of the FET 2, a process of correcting the command duty in which the duty is in short or in excess is performed as described above. Hereinafter, a method of correcting the duty will be described.

As shown in FIG. 1, a result of duty conversion (detected duty) performed on the motor terminal voltage by the duty converter 43 is input to the command duty correction circuitry 13. The command duty correction circuitry 13 includes an adder 13a and a subtractor 13b. As represented by Expression (1) provided below, the subtractor 13b calculates a difference (differential duty: ΔD) between the command duty (referred to as D_{A}) from the command duty generator 11 and the detected duty (referred to as D_{B}) output from the duty converter 43. Here, ΔD corresponds to the dead time ΔT described above.

Differential duty (ΔD)=command duty (D_{A})−detected duty (D_{B}) (1)

Furthermore, in the command duty correction circuitry 13, the differential duty (ΔD) obtained by the subtractor 36 and the command duty (D_{A}) are added in the adder 13a. The addition result is input to the PWM signal generator 17 as post-correction command duty (referred to as D_{C}). This is represented by Expression (2) provided below.

Post-correction command duty (D_{C})=command duty (D_{A})+differential duty (ΔD) (2)

The PWM signal generator 17 generates a PWM signal according to the post-correction command duty (D_{C}). For example, for the U phase, the HiSide FET 1 and the LoSide FET 2 are driven via the drivers 20a and 20b, respectively.

In the case of the phase current in the positive direction, the detected duty is smaller than the command duty. Therefore, the differential duty is added to the command duty in the duty correction represented by Expression (2) described above. Further, when the phase current flows in the negative direction, the detected duty exceeds the command duty. Therefore, the differential duty that takes a negative value is added to the command duty in the duty correction represented by Expression (2) described above. In other words, the differential duty is subtracted from the command duty.

When the carrier frequency of the PWM drive signal in the inverter control is 20 kHz, one cycle in FIGS. 3 and 5 is 50 μsec. Therefore, in the inverter control method according to the present example embodiment, the duty correction of each phase is updated every 50 μsec. That is, the duty correction process is performed at each timing of duty update.

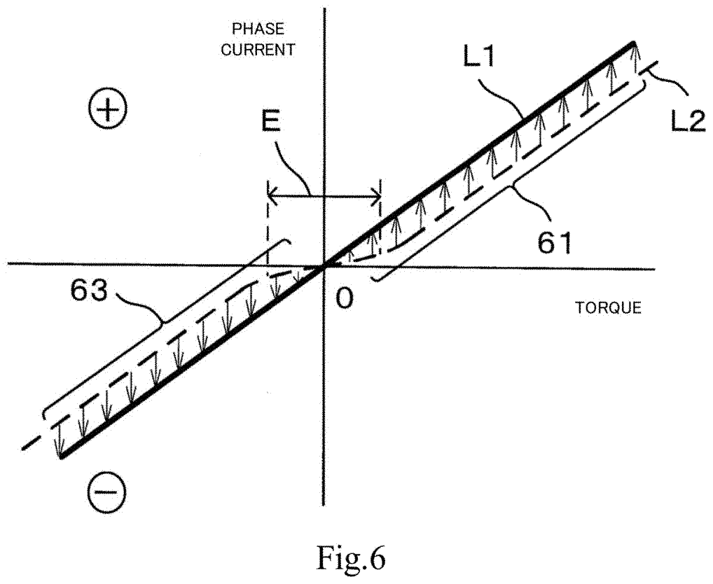

FIG. 6 schematically shows how duty correction (correction of phase current) is performed in the inverter control method according to the present example embodiment. In FIG. 6, a broken line L2 indicates the relationship between the phase current and the torque before correction, and a solid line L1 indicates the relationship between the phase current and the torque after correction.

As can be seen from a pre-correction characteristic L2 in FIG. 6, by providing a dead time to a drive signal of a switching element (FET), the current path (direction of the phase current) between the HiSide-FET and the LoSide-FET is switched from positive to negative, a step (range denoted by a symbol E in FIG. 6) is generated in the switching characteristic. Such a step appears more prominently as the dead time is longer, which causes a torque ripple.

As shown in FIG. 6, when the phase current is flowing in the positive direction, the phase current is lower than the ideal characteristic (solid line L1) in the portion indicated by a reference numeral 61 in the switching characteristic L2, and the duty is in an insufficient state. When the phase current flows in the negative direction, the phase current is on the upper side than the ideal characteristic (solid line L1) at the portion denoted by a reference numeral 63 in the switching characteristic L2, and the duty is in an excess state.

The detected duty described above is correlated with the direction of the current flowing in each phase, and the direction of the current can be known from the magnitude of the detected duty and the command duty. That is, when the detected duty is smaller than the command duty, the current in the positive direction flows in the phase, while when the detected duty is larger than the command duty, the current in the negative direction flows in the phase.

Therefore, in the inverter control method according to the present example embodiment, the direction of correction is switched according to the timing at which the direction of the phase current changes, and the duty correction process is performed by using the solid line L1 of FIG. 6 as an ideal characteristic so as to match the switching characteristic L2 before correction of the phase current with the switching characteristic L1 after the correction.

Specifically, in the range denoted by the reference numeral 61 of the pre-correction switching characteristic L2, a process of adding a deficient duty (differential duty) to the command duty is performed. As a result, correction is performed to add the phase current (duty) as indicated by the upward arrow in the range 61 of the characteristic L2. This allows the pre-correction switching characteristic L2 to match the post-correction switching characteristic L1.

Further, in the range denoted by the reference numeral 63 of the pre-correction switching characteristic L2, a process to subtract the excess duty (differential duty) from the command duty is performed. As a result, correction is performed by subtracting the phase current (duty) as indicated by the downward arrow in the range 63 of the pre-correction switching characteristic L2. This allows the pre-correction switching characteristic L2 to match the post-correction switching characteristic L1.

In the range denoted by the symbol E in FIG. 6, the correction amount (increase or decrease amount of the duty) for the command duty is smaller than that in the region where the phase current is large. In the inverter control method according to the present example embodiment, since the motor terminal voltage is converted to duty without detecting the phase current, torque control with a minute current is performed as in the range E, and even in a region where the characteristic curve becomes non-linear, that is, a region where the difference between the command duty and the detected duty is small, the difference between the command duty and the detected duty can be detected reliably. As a result, even in the minute current region, duty correction can be performed with high accuracy without making a mistake in the correction direction of the duty.

The inverter control method according to the present example embodiment has a configuration of performing duty control by providing the command duty generator 11 and the command duty correction circuitry 13 to the motor control device 1 of FIG. 1. However, the present disclosure is not limited thereto. For example, the functions of the command duty generator 11 and the command duty correction circuitry 13 may be implemented by software processing performed in the controller 30. In this case, a program for executing the software processing is stored in a memory 25. In the memory 25, operation values and the like necessary for the controller 30 to execute the duty correction process are temporarily stored, together with the processing program.

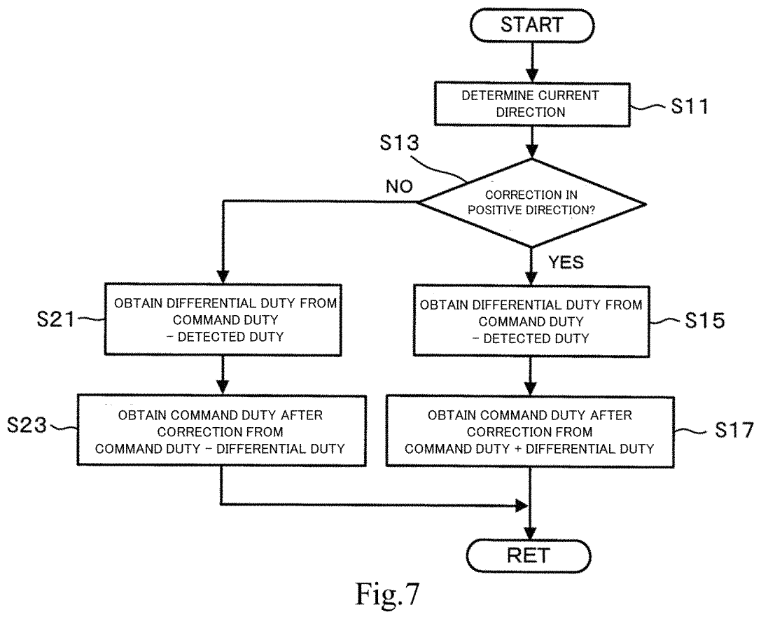

FIG. 7 is a flowchart showing an example of the duty correction process performed by the controller 30. In the first step (step S11 in FIG. 7), from a comparison result between the command duty output from the controller 30 and the detected duty output from the duty converter 23, the controller 30 determines the direction of the phase current of the motor driving phase.

Based on the determination result of the current direction, the controller 30 determines in step S13 which of the duty correction corresponding to the positive direction and the duty correction corresponding to the negative direction is to be performed. When the direction of the phase current is the positive direction, the controller 30 obtains the difference between the command duty and the detected duty (the above-mentioned differential duty: ΔD) in step S15. Then, in the subsequent step S17, the differential duty (ΔD) is added to the command duty to calculate a post-correction command duty.

On the other hand, when the direction of the phase current is the negative direction, the controller 30 obtains the difference (differential duty: ΔD) between the command duty and the detected duty in step S21. In the subsequent step S23, the differential duty (ΔD) is subtracted from the command duty to calculate a post-correction corrected command duty.

The controller 30 continuously performs the duty correction process on each of the U phase, the V phase, and the W phase, whereby the difference between the command duty output from the controller 30 and the actual duty is fed back to the controller 30. Therefore, even when the current path is switched during the ON/OFF driving of the FET, the phase current changes linearly by the duty correction, so that it is possible to avoid generation of a torque ripple due to a step.

The duty correction by the software processing shown in FIG. 7 is executed while updating every 100 to 200 μsec, for example.

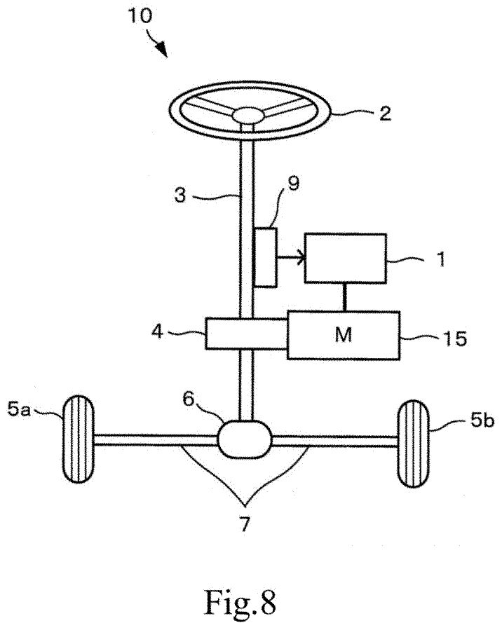

FIG. 8 shows a schematic configuration of an electric power steering apparatus equipped with a motor control device controlled by the inverter control method according to the present example embodiment. An electric power steering apparatus 10 in FIG. 8 includes a motor control device 1 as an electronic control circuitry (ECU), a steering wheel 2 that is a steering member, a rotating shaft 3 connected to the steering wheel 2, a pinion gear 6, a rack shaft 7, and the like.

The rotating shaft 3 is engaged with the pinion gear 6 provided at a distal end thereof. By the pinion gear 6, a rotational motion of the rotating shaft 3 is converted to a linear motion of the rack shaft 7 and a pair of wheels 5a and 5b provided at both ends of the rack shaft 7 is steered at an angle in accordance with the amount of displacement of the rack shaft 7.

A torque sensor 9 that detects a steering torque when the steering wheel 2 is operated is provided to the rotating shaft 3, and the detected steering torque is transmitted to the motor control device 1. The motor control device 1 generates a motor driving signal based on signals of the steering torque acquired by the torque sensor 9, a vehicle speed from a vehicle speed sensor (not shown), and the like, and outputs the signal to the electric motor 15.

An auxiliary torque for assisting the steering of the steering wheel 2 is output from the electric motor 15 to which the motor driving signal is input, and the auxiliary torque is transmitted to the rotating shaft 3 via a speed reduction gear 4. As a result, since the rotation of the rotating shaft 3 is assisted by the torque generated in the electric motor 15, the steering wheel operation of the driver is assisted.

As described above, the inverter control method according to the present example embodiment corrects the duty of the motor driving signal (pulse width modulation signal) based on the terminal voltage of the motor. Therefore, detection of the motor current and correction according to the sign of the current are unnecessary. Therefore, duty correction that matches the target motor drive can be realized with a simple configuration.

That is, by feeding back, to the controller, a differential duty value calculated from the duty value that the controller desires to output in the motor driving and the duty value that is actually output, it is possible to perform PWM control on the FETs of the inverter circuit by a signal in which the duty that is in short or in excess due to the dead time provided to the pulse width signal is corrected. In this case, when the motor is a three-phase motor, duty correction of the pulse width modulation signal can be performed for each phase of the inverter circuit that drives the three-phase motor.

In addition, since an increase or decrease fluctuation of the duty ratio corresponding to the target motor drive due to the dead time provided to the motor driving signal is compensated, it is possible to prevent shortage or excess of the motor driving current that is a problem in low current control such as around 50% duty particularly, to thereby suppress generation of a torque ripple.

Furthermore, by correcting the duty according to the current direction (direction of the phase current) of the motor determined based on the terminal voltage of the motor, it is possible to suppress occurrence of torque ripple at the switching timing of the motor current.

Further, in the motor control device for the electric power steering, by controlling the inverter circuit while correcting the duty of the motor driving signal (pulse width modulation signal) according to the actual operation based on the terminal voltage of the motor by the above-described inverter control method, it is possible to realize smooth steering assist by suppressing generation of a torque ripple in the motor for the electric power steering with a simple configuration.

The example embodiment of the present disclosure is not limited to the example embodiment described above, and various modifications are possible. For example, the configurations of the controller 30 and the pre-driver circuitry 40 of the motor control device 1 according to the above-described example embodiment are not limited to the examples shown in FIG. 1.

### First Modification

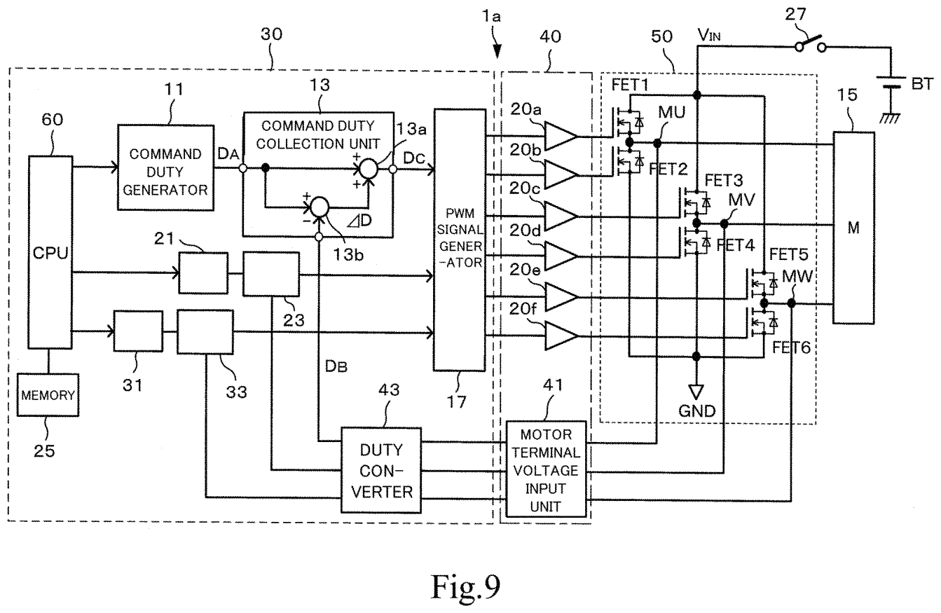

FIG. 9 is a block diagram showing a configuration of a motor control device according to a first modification. In a motor control device 1a according to the first modification, the pre-driver circuitry 40 includes drivers 20a to 20f and a motor terminal voltage input circuitry 41. The controller 30 includes the PWM signal generator 17, the duty converter 43, the command duty generators 11, 21, and 31, the command duty correction circuitry 13, 23, and 33, a CPU 60 that controls the entire control circuitry, and the like.

By doing this, the CPU 60 of the controller 30 realizes duty calculation, PWM generation, and the like by a software program stored in the memory 25. In addition, it is possible to respond flexibly and quickly to the changes in the specification of the inverter control and the like.

### Second Modification

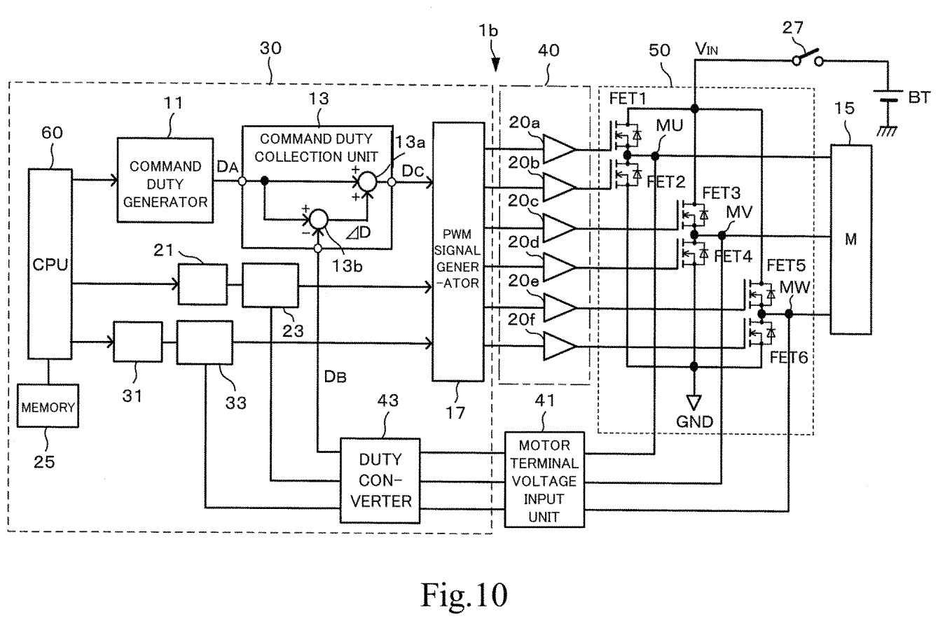

FIG. 10 is a block diagram showing a configuration of a motor control device according to a second modification. In a motor control device 1b according to the second modification, the pre-driver circuitry 40 includes the drivers 20a to 20f. The motor terminal voltage input circuitry 41 is configured independently. In this case, the motor terminal voltage input circuitry 41 is configured of, for example, discrete components.

On the other hand, the controller 30 includes the PWM signal generator 17, the duty converter 43, the command duty generators 11, 21, and 31, command duty correction circuitries 13, 23, and 33, the CPU 60 that controls the entire controller, and the like. Thereby, it is possible to implement duty calculation, PWM generation, and the like according to the software stored in the memory 25 by the CPU 60 of the controller 30 while simplifying the configuration of the pre-driver circuitry 40, and to flexibly respond to the changes in the specification of the inverter control and the like.

### Third Modification

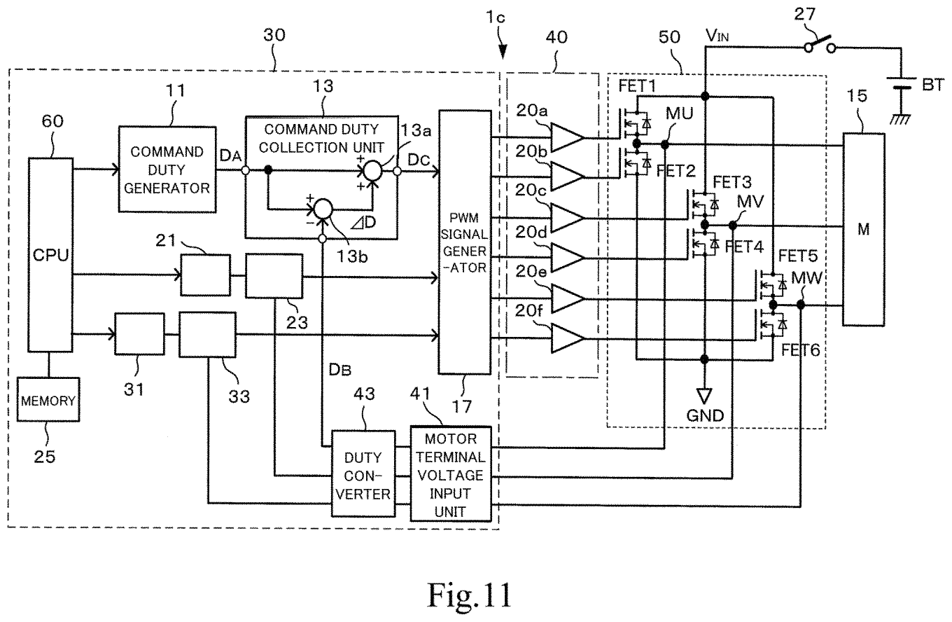

FIG. 11 is a block diagram showing a configuration of a motor control device according to a third modification. In a motor control device 1c according to the third modification, the pre-driver circuitry 40 includes the drivers 20a to 20f as in the second modification described above. However, the motor control device 1c has a configuration in which the motor terminal voltage input circuitry 41, having an independent configuration in the second modification, is included in the controller 30.

That is, the controller 30 includes the PWM signal generator 17, the motor terminal voltage input circuitry 41, the duty converter 43, the command duty generators 11, 21 and 31, the command duty correction circuitries 13, 23 and 33, the CPU 60 that controls the entire controller, and the like.

As described above, in the third modification, by integrating the functions other than the pre-driver function into the controller 30, it is possible to provide a flexible configuration in which inverter control can be completed by the controller 30 by the software stored in the memory 25 of the CPU 60.

Features of the above-described example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. An inverter control method that controls an inverter circuit that drives a motor, the method comprising the steps of:
detecting a terminal voltage of the motor driven by a predetermined pulse width modulation signal;
generating an actual duty ratio at a time of driving the motor based on the terminal voltage;
calculating a difference between a command duty ratio corresponding to a target motor drive and an actual duty ratio as a differential duty ratio;
correcting the command duty ratio based on the differential duty ratio; and
generating a corrected pulse width modulation signal that controls the inverter circuit based on a post-correction command duty ratio obtained by the correction.

2. The inverter control method according to claim 1, wherein
the corrected pulse width modulation signal includes a first drive signal and a second drive signal each having a dead time; and
an increase or decrease fluctuation of the command duty ratio due to the dead time is compensated by the differential duty ratio.

3. The inverter control method according to claim 2, wherein
the correcting includes:
adding the differential duty ratio to the command duty ratio when a current direction between the inverter circuit and the motor is a first direction; and
subtracting the differential duty ratio from the command duty ratio when the current direction is a second direction that is opposite to the first direction.

4. The inverter control method according to claim 3, wherein
the first direction corresponds to a state in which the actual duty ratio is less than the command duty ratio; and
the second direction corresponds to a state in which the actual duty ratio exceeds the command duty ratio.

5. A motor control device including an inverter circuit that drives a motor, the motor control device comprising:
circuitry configured to detect a terminal voltage of the motor driven by a predetermined pulse width modulation signal;
circuitry configured to generate the corrected pulse width modulation signal that controls the inverter circuit using the inverter control method according to claim 1 based on the terminal voltage; and
circuitry configured to control the motor based on the corrected pulse width modulation signal generated.

6. A motor control device including an inverter circuit that drives a motor, the motor control device comprising:
circuitry configured to detect a terminal voltage of the motor driven by a predetermined pulse width modulation signal;
circuitry configured to generate the corrected pulse width modulation signal that controls the inverter circuit using the inverter control method according to claim 2 based on the terminal voltage; and
circuitry configured to control the motor based on the corrected pulse width modulation signal generated.

7. A motor control device including an inverter circuit that drives a motor, the motor control device comprising:
circuitry configured to detect a terminal voltage of the motor driven by a predetermined pulse width modulation signal;
circuitry configured to generate the corrected pulse width modulation signal that controls the inverter circuit using the inverter control method according to claim 3 based on the terminal voltage; and
circuitry configured to control the motor based on the corrected pulse width modulation signal generated.

8. A motor control device including an inverter circuit that drives a motor, the motor control device comprising:
circuitry configured to detect a terminal voltage of the motor driven by a predetermined pulse width modulation signal;
circuitry configured to generate the corrected pulse width modulation signal that controls the inverter circuit using the inverter control method according to claim 4 based on the terminal voltage; and
circuitry configured to control the motor based on the corrected pulse width modulation signal generated.

9. The motor control device according to claim 5, wherein
the motor is a three-phase motor; and
the command duty ratio is corrected for each phase to generate the pulse width modulation signal.

10. The motor control device according to claim 6, wherein
the motor is a three-phase motor; and
the command duty ratio is corrected for each phase to generate the pulse width modulation signal.

11. The motor control device according to claim 7, wherein
the motor is a three-phase motor; and
the command duty ratio is corrected for each phase to generate the pulse width modulation signal.

12. The motor control device according to claim 8, wherein
the motor is a three-phase motor; and
the command duty ratio is corrected for each phase to generate the pulse width modulation signal.

13. A motor control device of an electric power steering that assists a steering wheel operation by an operator of a vehicle or the like, the motor control device comprising:
circuitry configured to detect a terminal voltage of a motor driven by a predetermined pulse width modulation signal;
circuitry configured to generate the corrected pulse width modulation signal that controls the inverter circuit using the inverter control method according to claim 1 based on the terminal voltage; and
circuitry configured to control the motor based on the corrected pulse width modulation signal generated.

14. A motor control device of an electric power steering that assists a steering wheel operation by an operator of a vehicle or the like, the motor control device comprising:
circuitry configured to detect a terminal voltage of a motor driven by a predetermined pulse width modulation signal;
circuitry configured to generate the corrected pulse width modulation signal that controls the inverter circuit using the inverter control method according to claim 2 based on the terminal voltage; and
circuitry configured to control the motor based on the corrected pulse width modulation signal generated.

15. A motor control device of an electric power steering that assists a steering wheel operation by an operator of a vehicle or the like, the motor control device comprising:
circuitry configured to detect a terminal voltage of a motor driven by a predetermined pulse width modulation signal;
circuitry configured to generate the corrected pulse width modulation signal that controls the inverter circuit using the inverter control method according to claim 3 based on the terminal voltage; and
circuitry configured to control the motor based on the corrected pulse width modulation signal generated.

16. A motor control device of an electric power steering that assists a steering wheel operation by an operator of a vehicle or the like, the motor control device comprising:
circuitry configured to detect a terminal voltage of a motor driven by a predetermined pulse width modulation signal;
circuitry configured to generate the corrected pulse width modulation signal that controls the inverter circuit using the inverter control method according to claim 4 based on the terminal voltage; and
circuitry configured to control the motor based on the corrected pulse width modulation signal generated.

17. An electric power steering system comprising the motor control device of the electric power steering according to claim 13.

18. An electric power steering system comprising the motor control device of the electric power steering according to claim 14.

19. An electric power steering system comprising the motor control device of the electric power steering according to claim 15.

20. An electric power steering system comprising the motor control device of the electric power steering according to claim 16.
